(19) United States
(12) Patent Application Publication
(10) Pub. No.: US 2023/0087618 A1
(43) Pub. Date: Mar. 23, 2023

(54) SYSTEM AND METHOD FOR DETERMINING LOCATION-BASED OCCURRENCE PROBABILITY DURING A LIVE EVENT

(71) Applicant: SIZ TECHNOLOGIES LTD, Tel Aviv (IL)

(72) Inventors: Kfir SHEINFELD, Tel Aviv (IL); Tal Hayon, Tel Aviv (IL)

(73) Assignee: SIZ TECHNOLOGIES LTD, Tel Aviv (IL)

(21) Appl. No.: 18/072,877

(22) Filed: Dec. 1, 2022

Related U.S. Application Data
(63) Continuation of application No. PCT/IL2021/050480, filed on Apr. 26, 2021.
(60) Provisional application No. 63/034,417, filed on Jun. 4, 2020.

(51) Int. Cl. G06T 7/20; G06V 20/52

(52) U.S. Cl. CPC G06T 7/20; G06V 20/52; G06T 2207/30221

(57) ABSTRACT

Systems and methods for determining location-based occurrence probability during a live event, including: receiving, from at least one sensor, movement data for at least one object moving in the live event, wherein the movement data comprises location data of the at least one object in the area of the live event, receiving statistical information for the at least one object, and dynamically determining an occurrence probability for movement of the at least one object, during progress of the live event, for each of a plurality of areas where the live event occurs, where the occurrence probability is determined based on the receiving movement data and based on the received statistical information, and wherein a size of each of the plurality of areas dynamically changes based on at least one of: the received movement data and the received statistical information.

### FIELD OF THE INVENTION

The present invention relates to determination of probability of an occurrence during a live event. More particularly, the present invention relates to systems and methods for determining location-based occurrence probability during a live event.

### BACKGROUND OF THE INVENTION

In recent years, some gambling companies began offering real-time betting on live events, sometimes depending on what happens in real time (e.g., occurring on the playing field or pitch of a sporting event). Users may find it desirable to wager on real-life events, such as live sporting events (e.g., Soccer, Football. Baseball. Basketball, etc.).

For example, in addition to trivial wagering outcomes, such as which one of the sports contestants will win, under/over 1.5 goals, etc., users may find it desirable to wager on variety of possible situations that may occur during these real-life events and which may derived from statistics (e.g., team/individual performance in past games, league table) and real-time data that may involve in-venue data (e.g., weather, pitch conditions, crowd, etc.), team or individuals performance (e.g., in terms of mental and physical aspects) during the live event.

Along with the live betting offered, and as part of a created user experience, these companies usually provide real-time tracking of the location of events on the field through a virtual broadcast that accurately illustrates what is happening (e.g., following movement of a football on the pitch). Thus, a user experience can be created where users can understand what is happening in the live event even if they do not watch the traditional broadcast (e.g., on a TV) and may therefore feel more comfortable to bet on the probability of an occurrence, for example place a bet on the probability of a particular player scoring a goal.

In addition, it may be possible to provide live and/or historical information, from dedicated data companies (e.g., INSTAT, OPTA SPORT, SPORT RADA, STATS, etc.), about the players and/or playing ball and/or any other action significant to the live event (e.g., a free kick, a penalty, etc.).

### SUMMARY

There is this provided, in accordance with some embodiments of the invention, a method of determining location-based occurrence probability during a live event, the method including: receiving, from at least one sensor, movement data for at least one object moving in the live event, wherein the movement data comprises location data of the at least one object in the area of the live event, receiving statistical information for the at least one object, and dynamically determining an occurrence probability for movement of the at least one object, during progress of the live event, for each of a plurality of areas where the live event occurs. In some embodiments, the occurrence probability is determined based on the received movement data and based on the received statistical information, and a size of each of the plurality of areas dynamically changes based on at least one of: the received movement data and the received statistical information.

In some embodiments, a pause is identified in the progress of the live event, based on the received movement data, and the occurrence probability determination is stopped during the identified pause In some embodiments, occurrence probability is determined based on occurrence probability calculated for at least one other event.

In some embodiments, the at least one sensor is selected from the group consisting of: wearable sensors configured to provide real-time performance data of the wearer, motion tracking sensors, “in-field” sensors, and cameras, the at least one object is a human player in a sporting event. In some embodiments, the at least one object is a hall in a sporting event.

There is this provided, in accordance with some embodiments of the invention, a system for determination of location-based occurrence probability during a live event, the system including: at least one sensor configured to transmit movement data for at least one object moving in the event, wherein the movement data comprises location data of the at least one object in the area of the live event, at least one database configured to store statistical information for the at least one object, and a processor, in communication with the at least one sensor and the at least one database, where the processor is configured to dynamically determine occurrence probability for movement of the at least one object, during progress of the live event, for each of a plurality of areas where the live event occurs.

In some embodiments, the occurrence probability is determined based on the received movement data and based on the received statistical information, and size of the plurality of areas dynamically changes based on at least one of: the received movement data and the received statistical information.

In some embodiments, the processor is configured to: identify a pause in the progress of the live event, based on the received movement data, and stop the occurrence probability determination during the identified pause. In some embodiments, occurrence probability is determined based on occurrence probability for at least one other event received from the at least one database.

In some embodiments, the at least one sensor is selected from the group consisting of: wearable sensors configured to provide real-time performance data of the wearer, motion tracking sensors, “in-field” sensors, and cameras. In some embodiments, the at least one object is a human player in a sporting event. In some embodiments, the at least one object is a ball in a sporting event.

There is this provided, in accordance with some embodiments of the invention, a method of determining location-based occurrence probability during a live event, the method including: receiving, from at least one sensor, interaction data for at least one static object in the event, wherein the interaction data comprises location data of the at least one static object in the area of the live event, receiving statistical information for the at least one static object, and dynamically determining occurrence probability for interaction of the at least one static object with at least one dynamic object, during progress of the live event, for each of a plurality of areas where the live event occurs.

In some embodiments, the occurrence probability is determined based on the received data and based on the received statistical information, and size of the plurality of areas dynamically changes based on at least one of: the received movement data and the received statistical information.

In some embodiments, a pause is identified in the progress of the live event, based on the received interaction data, and the occurrence probability determination is stopped during the identified pause. In some embodiments, occurrence probability is determined based on occurrence probability calculated for at least one other event. In some embodiments, the at least one sensor is selected from the group consisting of: wearable sensors configured to provide real-time performance data of the wearer, motion tracking sensors. “in-field” sensors, and cameras.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a block diagram of an exemplary computing device, according to some embodiments of the invention;

FIG. 2 shows a block diagram of a system for determination of location-based occurrence probability during a live event, according to some embodiments of the invention;

FIG. 3A shows an exemplary user interface display for a location-based occurrence probability wagering during a live event, according to some embodiments of the invention;

FIG. 3B shows another example of the user interface display for a location-based occurrence probability wagering during a live event, according to some embodiments of the invention;

FIG. 3C shows another example of the user interface display for a location-based occurrence probability wagering during a live event, according to some embodiments of the invention;

FIG. 3D shows another example of the user interface display for a location-based occurrence probability wagering during a live event, according to some embodiments of the invention; and

FIG. 4 shows a flowchart for a method of determining a location-based occurrence probability during a live event, according to some embodiments of the invention.

It will be appreciated that, for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components, modules, units and/or circuits have not been described in detail so as not to obscure the invention. Some features or elements described with respect to one embodiment may be combined with features or elements described with respect to other embodiments. For the sake of clarity, discussion of same or similar features or elements may not be repeated.

Although embodiments of the invention are not limited in this regard, discussions utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that may store instructions to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof can occur or be performed simultaneously, at the same point in time, or concurrently.

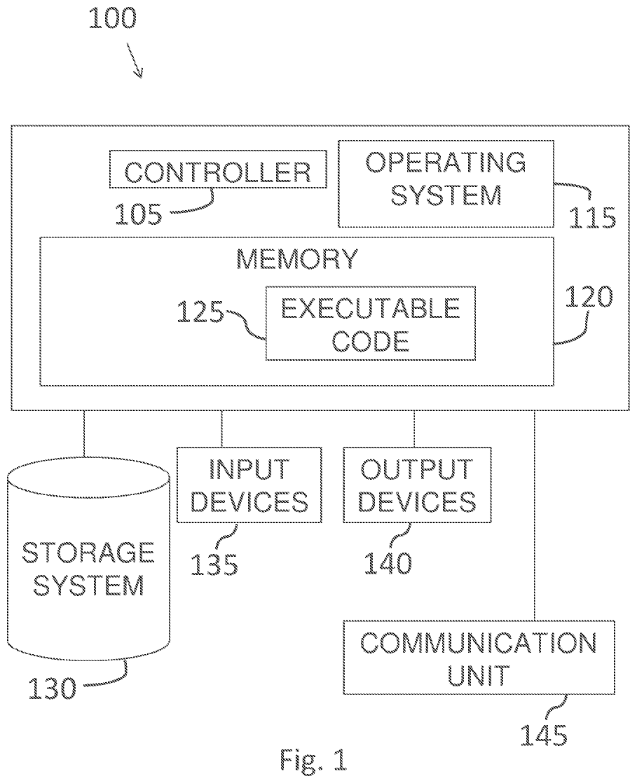

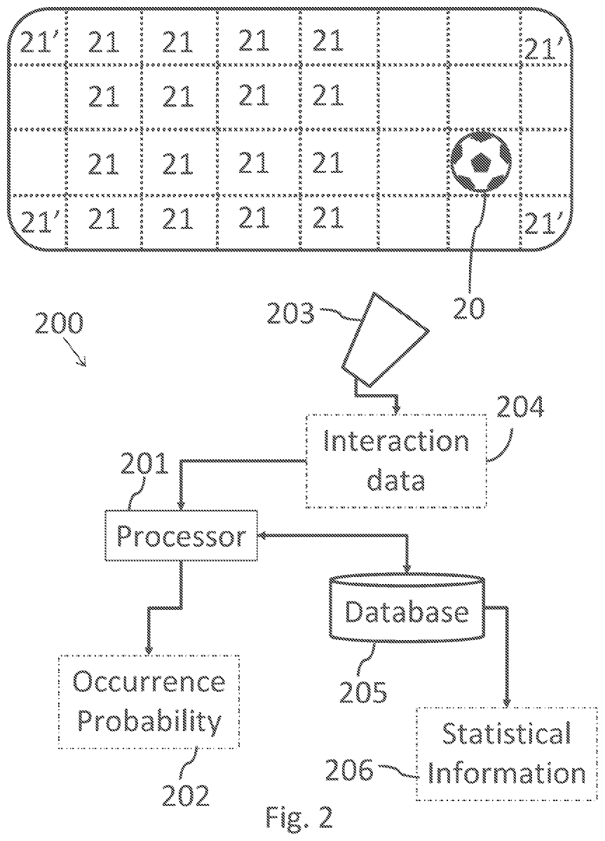

Reference is made to FIG. 1, which is a schematic block diagram of an example computing device 100, according to some embodiments of the invention. Computing device 100 may include a controller or processor 105 (e.g., a central processing unit processor (CPU), a programmable contoller or any suitable computing or computational device), memory 120, storage 130, input devices 135 (e.g. a keyboard or touchscreen), and output devices 140 (e.g., a display), a communication unit 145 (e.g., a cellular transmitter or modern, a Wi-Fi communication unit, or the like) for communicating with remote devices via a computer communication network, such as, for example, the Internet. The computing device 100 may operate by executing an operating system 115 and/or executable code 125. Controller 105 may be configured to execute program code to perform operations described herein. The system described herein may include one or more computing device 100, for example, to act as the various devices or the components shown in FIG. 2. For example, system 200 may be, or may include computing device 100 or components thereof.

Operating system 115 may be or may include any code segment (e.g., one similar to executable code 125 described herein) designed and/or configured to perform tasks involving coordinating, scheduling, arbitrating, supervising, controlling or otherwise managing operation of computing device 100, for example, scheduling execution of software programs or enabling software programs or other modules or units to communicate.

Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may be a computer or processor non-transitory readable medium, or a computer non-transitory storage medium, e.g., a RAM.

Executable code 125 may be any executable code, e.g., an application, a program, a process, task or script. Executable code 125 may be executed by controller 105 possibly under control of operating system 115. For example, executable code 125 may be a software application that performs methods as further described herein. Although, for the sake of clarity, a single item of executable code 125 is shown in FIG. 1, a system according to some embodiments of the invention may include a plurality of executable code segments similar to executable code 125 that may be stored into memory 120 and cause controller 105 to carry out methods described herein.

Storage 130 may be or may include, for example, a hard disk drive, a universal serial bus (USB) device or other suitable removable and/or fixed storage unit. In some embodiments, some of the components shown in FIG. 1 may be omitted. For example, memory 120 may be a non-volatile memory having the storage capacity of storage 130. Accordingly, although shown as a separate component, storage 130 may be embedded or included in memory 120.

Input devices 135 may be or may include a keyboard, a touch screen or pad, one or more sensors or any other or additional suitable input device. Any suitable number of input devices 135 may be operatively connected to computing device 100. Output devices 140 may include one or more displays or monitors and/or any other suitable output devices. Any suitable number of output devices 140 may be operatively connected to computing device 100. Any applicable input/output (I/O) devices may be connected to computing device 100 as shown by blocks 135 and 140. For example, a wired or wireless network interface card (NIC), a universal serial bus (USB) device or external hard drive may be included in input devices 135 and/or output devices 140.

Some embodiments of the invention may include an article such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out methods disclosed herein. For example, an article may include a storage medium such as memory 120, computer-executable instructions such as executable code 125 and a controller such as controller 105. Such a non-transitory computer readable medium may be, for example, a memory, a disk drive, or a USB flash memory, encoding, including or storing instructions, e.g., computer-executable instructions, which, when executed by a processor or controller, carry out methods disclosed herein. The storage medium may include, but is not limited to, any type or disk including, semiconductor devices such as read-only memories (ROMs) and/or random-access memories (RAMs), flash memories, electrically erasable programmable read-only memories (EEPROMs) or any type of media suitable for storing electronic instructions, including programmable storage devices. For example, in some embodiments, memory 120 is a non-transitory machine-readable medium.

A system according to some embodiments of the invention may include components such as, but not limited to, a plurality of central processing units (CPU) or any other suitable multi-purpose or specific processors or controllers (e.g., controllers similar to controller 105), a plurality of input units, a plurality of output units, a plurality of memory units, and a plurality of storage units. A system may additionally include other suitable hardware components and/or software components. In some embodiments, a system may include or may be, for example, a personal computer, a desktop computer, a laptop computer, a workstation, a server computer, a network device, or any other suitable computing device. For example, a system as described herein may include one or more facility computing device 100 and one or more remote server computers in active communication with one or more facility computing device 100 such as computing device 100, and in active communication with one or more portable or mobile devices such as smartphones, tablets and the like.

Reference is now made to FIG. 2, which show % a block diagram of a system 200 for determination of location-based occurrence probability (e.g., the probability of an occurrence based on location) during a live event, according to some embodiments. In FIG. 2, hardware elements are indicated with a solid line and the direction of arrows may indicate the direction of information flow.

For example, the location-based occurrence probability may be calculated for the statistical probability of an occurrence of a predefined event (e.g., position of a particular Basketball player) based on history of similar occurrences.

The system 200 may include a processor 201 (e.g., such as controller 105, shown in FIG. 1) configured to dynamically determine occurrence probability 202 for an interaction of at least one object 20, during progress of the live event, for each of a plurality of areas 21 where the live event occurs. In some embodiments, the determined occurrence probability 202 may be provided as a prediction for real time and/or location based wagers on live events, for example wagers for the number of times a particular player in a sports match scores a goal from a predefined area 21.

In some embodiments, the processor 201 may receive information for each live event, for further analysis. For example, the received data may include historic data regarding composition of a sports team, positioning of a sports team, a musical performance, etc., or statistical information (e.g., scoring statistics) on a particular object such as ball handling by specific players. In another example, the received data may include real time data for the live event, such as current ball handling by specific players, injuries of players, scores, tickets, composition of a sports team, etc. During analysis by the processor 201, the ratio for a particular probability at a dedicated location at the event may be different for the same ratio in a different time (e.g., for a following bet) since the real time data may be different and all ratio or odds change during the live event.

According to some embodiments, when three sport events are occurring simultaneously (e.g., in real-time), the processor 201 may calculate the occurrence probability 202 for the location at area 21 from which the ball 20 may move to the target (e.g., a goal or a basket), for each one of the three events. The occurrence probability 202 may be calculated with different outcome for each area 21 (e.g., having different sizes).

In some embodiments, the processor 201 may calculate the occurrence probability 202 for the location at area 21 from which at least one ball 20 may move to the target (e.g., a goal or a basket), for each game separately.

In some embodiments, the processor 201 may calculate the occurrence probability 202 for the location at area 21 where the object 20 will be at a predetermined time, for instance within half a minute (e.g., similarly to a roulette betting table where the bet is on the area 21).

In case that multiple events are occurring simultaneously (e.g., in real-time), the processor 201 may calculate the occurrence probability 202 for all objects 20 from the multiple events to be in the same location at a particular area 21 a predetermined time, for instance within half a minute. In some embodiments, the processor 201 may calculate the occurrence probability 202 for at least one objects 20 from multiple events occurring simultaneously to be in more than one area 21 a predetermined time, for instance within half a minute.

For example, a group of users may participate in occurrence prediction where the processor 201 may calculate the occurrence probability 202 for object 20 to be in a particular area 21, such that each user may see prediction of other users (e.g., see other areas marked with different colors).

Some previously available wagers for live events included wagers for probability of a particular team to score a goal in the next minute, and/or of a certain group to concede a yellow/red card in the next minute, and/or if a corner kick occurs in the next minute, where the location of the occurrence of the event does not constitute a factor for the production and supply of the wager, but merely its occurrence within the time limit. However, using the system 200 for determination of location-based occurrence probability during a live event, it may be possible to offer location-based wagers based on the determined occurrence probability, e.g., for different areas at the live event. For example, a prediction on from which part of the pitch the next goal may be scored, and/or in which part of the pitch the next card may be pulled out, and/or from which area the hall may arrive and cause the next corner kick.

In some embodiments, location-based wagers may also be provided for multiple events carried out in parallel. For example, the occurrence probability for a location of the forward in each one of four football matches played simultaneously.

According to some embodiments, each wager or prediction generated during the live event (e.g., a sports match) may refer to a specific real-time condition (e.g., a foul shot in Basketball, a corner kick in Football, etc.), where each wager or prediction may have one or more possible outcomes (e.g., scoring one of two Basketball foul shots, scoring both shots, missing both shots or scoring the first shot and catching the rebound ball of the missed second shot) and each outcome may be designated with a generated odd. Following the generation of a betting event, each participating user may choose one or more desirable outcomes and enter related stakes.

The at least one object 20 may be a static object (e.g., a Basketball hoop or a fence) or a dynamic object such as a player in a sporting event, a playing ball, etc. Dynamic objects and/or static objects may interact with another object during the live event such that a corresponding occurrence probability may be calculated. Other examples of static objects may include marking lines on the pitch (e.g., of a football match), penalty area, goal line, corner of the field of play, drums in a music concert, and the size of the playing pitch (e.g., the size of a football pitch may vary between 90 meters and 120 meters).

Accordingly, an interaction of the at least one object 20 during the live event (e.g., a sports game or a music concert), may be an interaction of the at least one object 20 with at least one other object. For example, such interactions may include two dynamic objects such as a player kicking a ball, or may include a static object such as a singer touching a microphone, or a basketball touching a Basketball hoop.

The system 200 may include at least one sensor 203 to capture interaction data 204, such as location or movement data, for at least one object 20 in the event (e.g., movement of a tennis ball or movement of a tennis player across the playing field). For example, the at least one sensor 203 may include wearable sensors configured to provide real time data relative to physical performance of the wearer (e.g., of an athlete, sportsman or a musician) such as miniature magneto-inertial sensors or other types of sensors ideal for obtaining sport performance measures during competition, motion tracking sensors (e.g., GPS) or any other forms of “in-field” sensors (e.g., sensors suitable to provide data relative to activities that occur in real-time during live sporting events and may include data relative to the weather, pitch condition, crowed or other suitable in-venue data), one or more cameras suitable to capture activities that occur during the live sporting event, etc. In some embodiments, the interaction data 204 (e.g., movement data) may include location data of the at least one object in the area of the live event.

The at least one sensor 203 may be selected from the group consisting of: wearable sensors configured to provide real-time performance data of the wearer, motion tracking sensors (e.g., embedded in a shoe of a player), “in-field” sensors, heat sensors, and cameras. In some embodiments, the at least one sensor 203 may receive information from a human operator that is present at the live event.

In some embodiments, the at least one sensor 203 may capture interaction data 204 for a static object 20, for instance the at least one sensor 203 may capture the amount of times a particular player of a Basketball team touches the Basketball hoop.

The at least one sensor 203 may be in active communication with the processor 201, and the at least one sensor 203 may be configured to transmit the captured interaction data 204 to the processor 201 for analysis.

In some embodiments, the system 200 may include at least one database 205 (e.g., such as storage system 130, shown in FIG. 1), configured to store statistical information 206 for the at least one object 21).

The statistical information 206 may include information about live or historical actions, ratios and ratio probabilities, a team, a player, a musician, a ball, a game, past results, charts, statistics, ball possession percentages, or event locations and any other geographic or location based information.

The at least one database 205 may be operably coupled to the processor 201 such that the occurrence probability 202 may be determined based on the received interaction data 204 (from the at least one sensor 203) and based on the received statistical information 206 (from the database 205).

According to some embodiments, the processor 201 may analyze the received interaction data 204 and/or the statistical information 206 in order to determine occurrence probability for actions that have not yet occurred in the live event. In some embodiments, the processor 201 may analyze information using predefined rules and/or formulas to adjust the ratios. For example, the processor 201 may analyze initial ratios (e.g., created for some past or future wager or prediction) in order to deduce how to generate predictions of rations and/or how to generate dynamic wages, where the information changes during the live event (e.g., depending on the score in a sports match, time, etc.).

In some embodiments, the processor 201 may receive dedicated guidelines or rules for generation of prediction, and/or ratios. For example, the odds for scoring a goal from the second half of the court may not depend on analysis of historic and/or real-time data, and may be calculated based on a predefined rule since this is a low probability event. Accordingly, predefined rules may be received for various occurrences of each type of live event.

For example, the processor 201 may predict or determine the occurrence probability for the location of the ball in a sports game in 15 seconds from now. In another example, the processor 201 may predict or determine the occurrence probability for a certain defense player to pass the half line and/or reach a certain position in the next minute.

In some embodiments, any live sports event with a pitch may be divided into areas in any form (e.g., Soccer, Basketball, Football, Hockey, Baseball, Horse Racing, Athletics, Water-Ball, UFC etc.). Accordingly, the determination of the occurrence probability 202 may be for occurrence of an interaction in these areas.

For example, in Football, occurrence probability may be calculated for a particular player to reach a certain part of the pitch in the next 30 seconds, in Soccer, occurrence probability may be calculated for which part of the pitch will the ball be 15 seconds from now, in Tennis, occurrence probability may be calculated for which part of the pitch will the ball hit most often in the upcoming set, and in Volleyball, occurrence probability may be calculated for what part of the pitch will the point be made. In another example, for instance in Soccer, occurrence probability may be calculated for which of the two goalkeepers to leave the goal area, or which center back player cross first the half field line. In some embodiments, the processor 201 may determine the occurrence probability 202 for location based events (e.g., sport events) between players of the same team or rival teams, and/or for a particular object in the event.

In some embodiments, the processor 201 may determine the occurrence probability 202 based on occurrence probability for at least one other event received from the at least one database 205.

According to some embodiments, size of the plurality of areas 21 may dynamically change based on at least one of: the type of the playing pitch and/or the received interaction data 204 and/or the received statistical information 206. For example, in a Basketball match, when all players are on one half of the Basketball court, the areas 21 of the other half of the Basketball court may be combined into a single area with the size of half a Basketball court.

For example, the playing pitch may be dynamically mapped or divided to different areas (e.g., similarly to a roulette betting surface) with different ratios depending on what is happening in the event such that the processor 201 may analyze data about the teams and the game in order to allow the user to choose one or more areas where the ball should be in 15 seconds. Thus, multiple wagers may be carried out for different locations of the areas 21 (e.g., similarly to a roulette betting table) and accordingly provide an enhanced user experience, for instance compared to previously available wagering systems where the user is able to place a single wager each time.

In some embodiments, the calculation of the occurrence probability 202 may be based on predefined rules. For example, the probability that after a predefined time period, for instance after half a minute, the object 20 may be at the edge of the event area (e.g., at the corner of a Football field) may be smaller than the probability that object 20 is adjacent to the center of the event area.

According to some embodiments, at least one area 21′ at predefined locations (such as at corners of a Basketball court) may have a larger size compared to areas 21 adjacent to the center of the event area, for instance having corresponding different ratios for predictions or wagers. In some embodiments, the size of the corner areas 21′ may have a smaller size compared to areas 21 adjacent to the center of the event area, for instance when the location of majority of players are near the corner areas 21′.

In some embodiments, the size of each area 21 may be different (e.g., areas at sides of the playing pitch may be larger) such that the wagering ratio for each area 21 may be associated to it's size. Additionally, the size of the areas 21 may dynamically change based on the occurrence in the live event.

For example, when the playing ball moves towards a particular portion of the pitch the areas 21 there may become smaller and/or the wagering ratio for these areas 21 may increase. In another example, when a player in a sports match is removed (e.g., due to a penalty), the ratio for the areas may accordingly change since the opposing team is left with more players and thus have higher chance of controlling the ball.

According to some embodiments, the size of the areas 21 may change dynamically in accordance with the occurrence at the live event, while the ratios for wagers or predictions may be different even for areas 21 having similar sizes. For example, all ratios for the areas 21 may be similar while the areas 21 may have different sizes.

In some embodiments, the determination of the occurrence probability 202 and/or the change in areas 21 may be based on the type of occurrence (e.g., movement of the ball). For example, when a forward player moves along the pitch while engaging the ball, the defense area of that team may be changed to a larger size since the probability of the ball being at the other side of the pitch is higher. Additionally, the areas at the side of the pitch may get smaller ratios, since forward players usually do not engage these areas.

In some embodiments, the size of each area 21 may be different while having a fixed wagering ratio, such that the ratios taken into account for determination of the occurrence probability 202 may depend on the sizes/location of the areas 21. For example, if all areas 21 are static with fixed ratio of 2:1, where the occurrence probability 202 may be calculated based on the size of the area 21 associated with that occurrence.

According to some embodiments, the processor 201 may update or suspend the determination of the occurrence probability 202 upon identification of a pause in the progress of the live event. The identification of the pause may be based on the received interaction data (e.g., movement data of a dynamic object).

For example, in a sports match when a substitute player is placed or a player is injured or after a penalty card and the game is paused, the system 200 must know to stop some of the wagers until the game is resumed, since the locations of objects do not change when the game is paused. Additionally, wagers for future event (e.g., location of the ball in 15 seconds) may no longer be valid when the game is paused.

In some embodiments, identification of the pause may be based on image processing, for example, identifying that a player is injured, and all other players stopped running. In some embodiments, identification of the pause may be based on location data received from at least one object interacting in the live event, for example receiving location data from a chip embedded into the playing ball in a sports match. In another example, identification of the pause may be determined manually by a human operator that is present at the live event.

According to some embodiments, the processor 201 may analyze data for a plurality of simultaneous live events (e.g., multiple Basketball matches) that are carried out in parallel. The system 200 may accordingly create parallel occurrence probabilities to be determined by the processor 201. For example, similarly to a lottery where bets are placed for multiple probabilities and the winner receives a prize based on the amount of correct guesses.

In order to determine the occurrence probabilities for each event, the occurrence for each location may be calculated. For example, the occurrence probability for a football to be located at the corner of the field for four events carried out simultaneously, may be lower (e.g., with a higher wager stake) than the occurrence probability for a football to be located at the center of the field for four events carried out simultaneously.

For example, the processor 201 may determine the occurrence probability for the basketball to reach a particular area in the pitch for all ongoing Basketball matches, and accordingly have a similar wager for all users (e.g., displaying several balls to the user, each with a different color where the user needs to choose the position of the ball). In another example, the processor 201 may determine simultaneously several occurrence probabilities for several possible occurrences (e.g., will the hall be in same portion of the pitch for all events or in a particular portion of the pitch or will the ball be kicked from the same portion of the pitch).

Such a parallel wager may include higher ratios since the occurrence probability may be harder to determine. In some embodiments, the system 200 may calculate the occurrence probability and/or the corresponding wagers presented to the user based on information from a plurality of live events as well as based on the occurrence in each of the live events (e.g., the ratios for one of the events may be lower due to a specific action happening at that time).

For example, the processor 201 may determine the occurrence probability for five sports matches occurring simultaneously. Each one of these sports matches may be displayed with the pitch divided into a plurality of areas (e.g., with different sizes), for example areas on a Basketball court. The users may select the areas where they predict the basketball may be in a particular time frame. In case that out of the predictions for the five matches, at least three predictions were correct, then the ratio for that occurrence (or wager) may be increased accordingly. In another example, the users may predict which side of the Basketball court receives more basketballs in a particular time frame. In case that out of the predictions for the five matches, at least three prediction of the side (e.g., left side) were correct, then the ratio for that occurrence (or wager) may be increased accordingly. It should be noted that various configurations of occurrence probabilities may be calculated, with different ratios (or wagers).

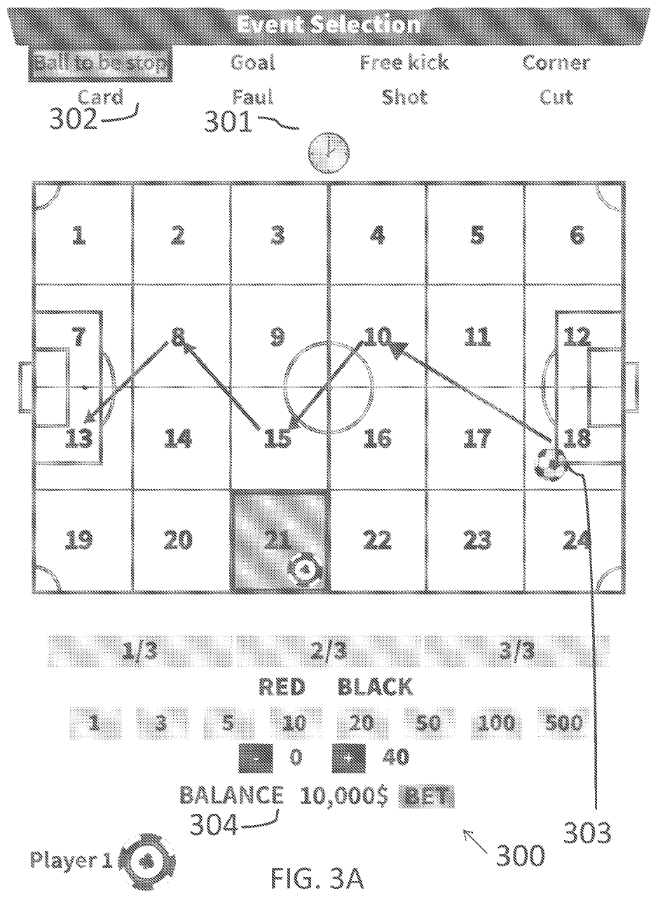

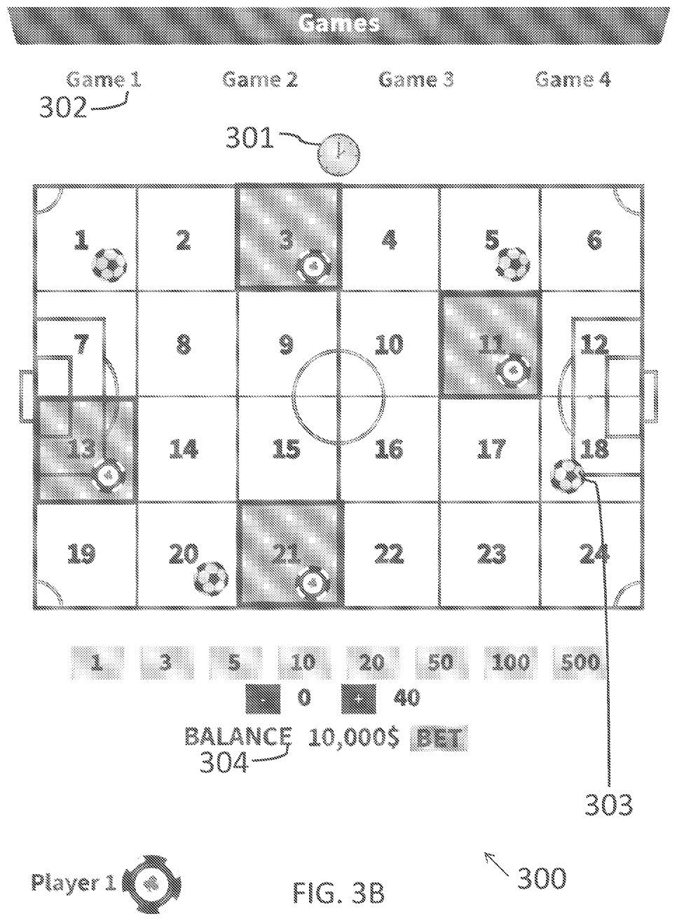

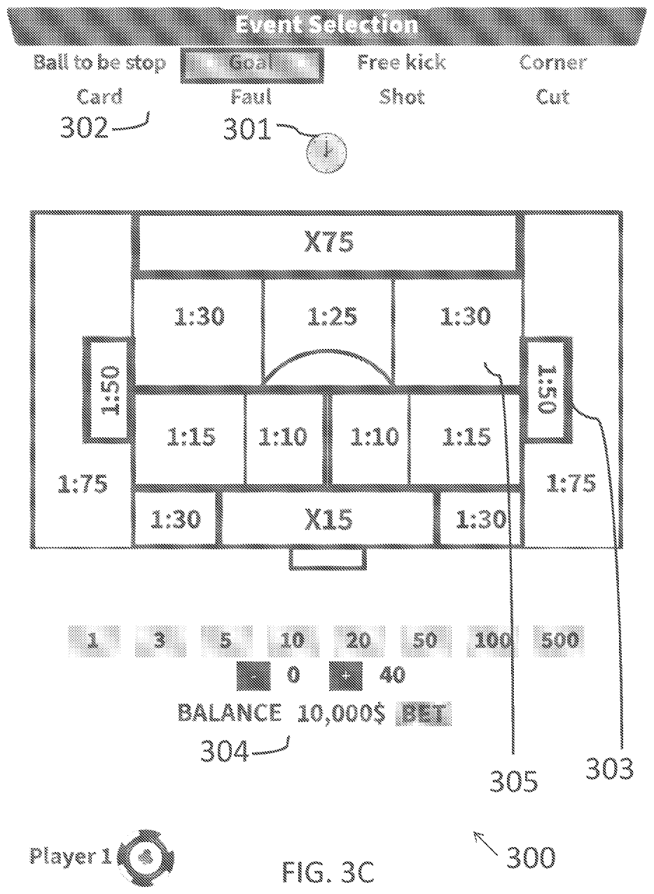

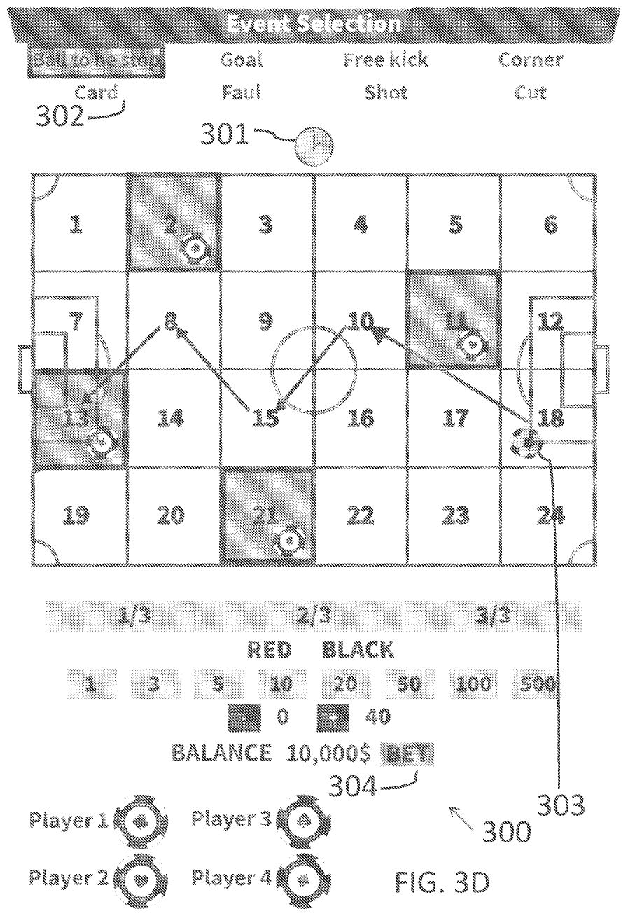

Reference is now made to FIGS. 3A-3D, which show several examples of user interface display 300 for a location-based occurrence probability wagering during a live event, according to some embodiments.

The display 300 may include live traditional and/or virtual streaming/broadcasting or any other form presenting the event, where the field may be divided in different shapes and/or sizes depending on the nature of the event.

A timer or stopwatch 301 may also be displayed, with a time interval for placing wagers, the remaining time for the wager activation, stopping the wager, starting the wager, etc. The display 300 may include fixed and/or dynamic ratios for all or part of the pitch (e.g., depending on the type of wager).

An event selection portion 302 may be displayed with different types of wagering options. The users may select where the ball will stop/fall in the next interval and/or may choose a different event to wager on (e.g., where will be the next out or penalty). For example, selection of the area may be similar to placing a bet on a virtual roulette table.

A ball tracking portion 303 may be displayed with ball movement tracking (e.g., real, virtual, over the event). Different markets 304 may be displayed with different markets and betting types (such as a side bet or multiple bet).

As shown in FIG. 3C, a box selection portion 305 may be displayed with the selected area (e.g., the user may pick one or more) and the winning area in different colors. The odds portion may be displayed with each area displaying a specific ratio that reflect the actual probability.

In some embodiments, the wagering system (e.g., with the user interface shown in FIGS. 3A-3D) may be a standalone site, as a widget embedded on existing systems or sites, as a toolbar that joins the broadcast, as a standard or virtual broadcast-linked bet, or physically on the screen.

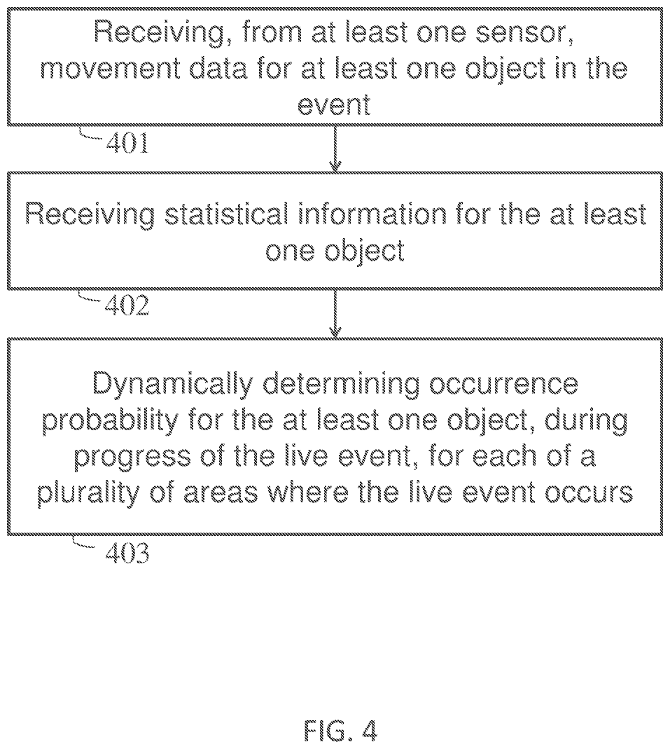

Reference is now made to FIG. 4, which shows a flowchart of a method of determining location-based occurrence probability during a live event, according to some embodiments.

In Step 401, interaction data (e.g., movement data) for at least one object (moving) in the event may be received from at least one sensor. In Step 402, statistical information for the at least one object may be received.

In Step 403, occurrence probability may be dynamically determined for the at least one object, during progress of the live event, for each of a plurality of areas where the live event occurs.

According to some embodiments, the occurrence probability may be determined based on the received interaction data and based on the received statistical information. In some embodiments, the size of the plurality of areas may dynamically change based on at least one of: the received movement data and the received statistical information.

While certain features of the invention have been illustrated and described herein, many modifications, substitutions, changes, and equivalents may occur to those skilled in the art. It is, therefore, to be understood that the appended claims are intended to cover all such modifications and changes as fall within the invention.

Various embodiments have been presented. Each of these embodiments may, of course, include features from other embodiments presented, and embodiments not specifically described may include various features described herein.

1. A method of determining location-based occurrence probability during a live event, the method comprising:
receiving, from at least one sensor, movement data for at least one object moving in the live event, wherein the movement data comprises location data of the at least one object in the area of the live event;
receiving statistical information for the at least one object; and
dynamically determining an occurrence probability for movement of the at least one object, during progress of the live event, for each of a plurality of areas where the live event occurs,
wherein the occurrence probability is determined based on the received movement data and based on the received statistical information, and wherein a size of each of the plurality of areas dynamically changes based on at least one of: the received movement data and the received statistical information.

2. The method of claim 1, further comprising:
identifying a pause in the progress of the live event, based on the received movement data; and
stopping the occurrence probability determination during the identified pause.

3. The method of claim 1, wherein occurrence probability is determined based on occurrence probability calculated for at least one other event.

4. The method of claim 1, wherein the at least one sensor is selected from the group consisting of: wearable sensors configured to provide real-time performance data of the wearer, motion tracking sensors, “in-field” sensors, and cameras.

5. The method of claim 1, wherein the at least one object is a human player in a sporting event.

6. The method of claim 1, wherein the at least one object is a ball in a sporting event.

7. A system for determination of location-based occurrence probability during a live event, the system comprising:
at least one sensor configured to transmit movement data for at least one object moving in the event, wherein the movement data comprises location data of the at least one object in the area of the live event;
at least one database configured to store statistical information for the at least one object; and
a processor, in communication with the at least one sensor and the at least one database, wherein the processor is configured to dynamically determine occurrence probability for movement of the at least one object, during progress of the live event, for each of a plurality of areas where the live event occurs,
wherein the occurrence probability is determined based on the received movement data and based on the received statistical information, and wherein size of the plurality of areas dynamically changes based on at least one of: the received movement data and the received statistical information.

8. The system of claim 7, wherein the processor is configured to:
identify a pause in the progress of the live event, based on the received movement data; and
stop the occurrence probability determination during the identified pause.

9. The system of claim 7, wherein occurrence probability is determined based on occurrence probability for at least one other event received from the at least one database.

10. The system of claim 7, wherein the at least one sensor is selected from the group consisting of: wearable sensors configured to provide real-time performance data of the wearer, motion tracking sensors, “in-field” sensors, and cameras.

11. The system of claim 7, wherein the at least one object is a human player in a sporting event.

12. The system of claim 7, wherein the at least one object is a ball in a sporting event.

13. A method of determining location-based occurrence probability during a live event, the method comprising:
receiving, from at least one sensor, interaction data for at least one static object in the event, wherein the interaction data comprises location data of the at least one static object in the area of the live event;
receiving statistical information for the at least one static object; and
dynamically determining occurrence probability for interaction of the at least one static object with at least one dynamic object, during progress of the live event, for each of a plurality of areas where the live event occurs,
wherein the occurrence probability is determined based on the received data and based on the received statistical information, and wherein size of the plurality of areas dynamically changes based on at least one of: the received movement data and the received statistical information.

14. The method of claim 13, further comprising:
identifying a pause in the progress of the live event, based on the received interaction data; and
stopping the occurrence probability determination during the identified pause.

15. The method of claim 13, wherein occurrence probability is determined based on occurrence probability calculated for at least one other event.

16. The method of claim 13, wherein the at least one sensor is selected from the group consisting of: wearable sensors configured to provide real-time performance data of the wearer, motion tracking sensors, “in-field” sensors, and cameras.
